(19) United States
(12) Patent Application Publication
(10) Pub. No.: US 2019/0102120 A1
(43) Pub. Date: Apr. 4, 2019

(54) PRINTING APPARATUS, CONTROL METHOD FOR PRINTING APPARATUS, AND STORAGE MEDIUM

(71) Applicant: CANON KABUSHIKI KAISHA, Tokyo (JP)

(72) Inventor: Takayuki Kaneko, Machida-shi (JP)

(21) Appl. No.: 16/140,092

(22) Filed: Sep. 24, 2018

(30) Foreign Application Priority Data
Sep. 29, 2017 (JP) 2017-191744

(51) Int. Cl. G06F 3/12

(52) U.S. Cl. CPC G06F 3/126; G06F 3/1238; G06F 3/1267; G06F 3/1254; G06F 3/1258; G06F 3/1204; G06F 3/1274

(57) ABSTRACT

A printing apparatus is provided where, if the printing apparatus is set to a hold printing mode, if a reserved printing job for which a designated print time is provided is received during the hold printing mode, print processing of the reserved printing job is not executed at the designated print time.

### BACKGROUND

### Field

The present disclosure relates to a printing apparatus, a control method for the printing apparatus, and a storage medium.

### Description of the Related Art

With the recent widespread use of network environments, it has become more common that a plurality of printing apparatuses is shared and used by a plurality of users.

Under such circumstances, if a printing apparatus is exclusively used by a specific user to perform a large amount of print processing, other users cannot use the printing apparatus, which may cause a problem for work. In this regard, a technique of “reserved printing” is proposed in Japanese Patent Application Laid-Open No. 2000-351254. In this technique, a print start time is designated in a case where a printing job is input from a printer driver so that printing is executed during a period in which the frequency of usage of a printing apparatus is low, such as at midnight or during a lunch break, and printing is started at the designated time. A technique of “hold printing” is proposed in Japanese Patent Application Laid-Open No. 2009-143081. In this technique, a received printing job is temporarily held in a printing apparatus without promptly performing printing based on the printing job, and printing is executed when a print instruction is provided via a user's operation. The execution of hold printing prevents disclosure of information caused by a user leaving a printed material at the printing apparatus before retrieving it. The technique of “hold printing” includes a method of designating hold printing for each printing job from a printer driver, and a method (forcible hold printing) of holding a printing job in a printing apparatus based on a setting in the printing apparatus, regardless of the setting in the printer driver.

Thus, “reserved printing” and “hold printing” are extremely useful as printing systems for their intended purposes. However, a printing system using a combination of “reserved printing” and “hold printing” has not been considered in the related art.

For example, if printing is scheduled to be executed at a designated time in a case where a printing apparatus set in a forcible hold printing mode receives a reserved printing job, the purpose of hold printing, i.e., the purpose of preventing a printing material from being left unattended, cannot be achieved.

### SUMMARY OF THE INVENTION

Aspects of the present disclosure are intended to address the above-described issues.

According to an aspect of the present disclosure, a printing apparatus that receives a reserved printing job for which a print time is designated and executes printing based on the reserved printing job according to the designated print time, includes a first setting unit configured to set whether to operate in a hold printing mode in which a received printing job is held and printing is executed based on the held printing job based on a print instruction and a control unit configured to perform control not to execute print processing based on of a reserved printing job received during operation in the hold printing mode.

According to another aspect of the present disclosure, a control method for a printing apparatus that receives a reserved printing job for which a print time is designated and executes printing based on the reserved printing job includes setting whether to operate in a hold printing mode in which a received printing job is held and printing is executed based on the held printing job based on a print instructions and performing control not to execute print processing of a reserved printing job received during operation in the hold printing mode.

Further features will become apparent from the following description of exemplary embodiments with reference to the attached drawings.

### BRIEF DESCRIPTION OF THE DRAWINGS

FIG. 1 illustrates a system configuration.

FIG. 2 is a block diagram illustrating a configuration of an information processing terminal.

FIG. 3 is a block diagram illustrating a configuration of a printing apparatus (image forming apparatus).

FIG. 4 is a block diagram illustrating modules of a control program for the information processing terminal.

FIG. 5 is a block diagram illustrating modules of a control program for the printing apparatus.

FIG. 6 is a flowchart illustrating printing job reception processing in the printing apparatus.

FIG. 7 is a flowchart print processing for a reserved printing job in the printing apparatus.

FIG. 8 is a flowchart illustrating an outline of print processing for a hold printing job in the printing apparatus.

FIG. 9 is a flowchart illustrating printing job reception processing in the printing apparatus.

FIG. 10 illustrates an example of a print instruction screen for a printer driver.

FIG. 11 illustrates an example of a user authentication screen of the printing apparatus.

FIGS. 12A and 12B are examples of a list screen for a hold printing job and a list screen for a reserved printing job, respectively, of the printing apparatus.

FIG. 13 illustrates an example of a forcible hold printing mode setting screen in the printing apparatus.

FIG. 14 illustrates an example of the forcible hold printing mode setting screen in the printing apparatus.

FIG. 15 illustrates a configuration example of a printing job.

FIG. 16 is a table illustrating an example of a printing job list.

FIG. 17 is a table illustrating an example of a printing job list.

### DESCRIPTION OF THE EMBODIMENTS

Exemplary embodiments for implementing the present disclosure will be described below with reference to the drawings.

In a first exemplary embodiment, a control method for a printing job in a case where a printing apparatus receives a printing job (the print job is hereinafter referred to as a reserved printing job) for which a print start time (hereinafter referred to as a reserved time) is designated, from an external device such as an information processing terminal. In particular, a control method in a case where the printing apparatus receives a reserved printing job when a forcible hold printing mode is enabled will be described.

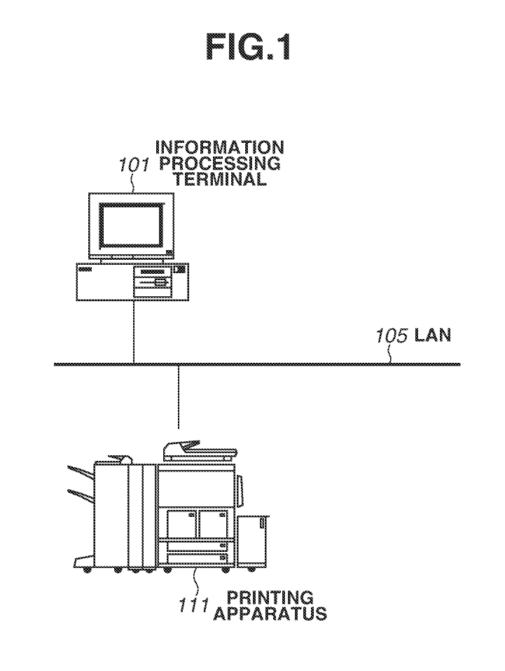

FIG. 1 illustrates a configuration of a printing system. In FIG. 1, an information processing terminal 101 is a terminal connectable to a network. A printing apparatus 111 performs printing based on a printing job received from the information processing terminal 101. The present exemplary embodiment is described assuming that a multi-function printer (MFP) including a configuration with a plurality of integrated functions such as a printing function, a reading function, and a facsimile (FAX) function is used as the printing apparatus 111. However, printing apparatuses with configurations other than the above-described configuration, such as a single-function printer (SFP) or a laser beam printer (LBP), can also be used. The information processing terminal 101 and the printing apparatus 111 are communicably connected via a network, such as a local area network (LAN) 105. A plurality of information processing terminals 101 and a plurality of printing apparatuses 111 can be connected, and another apparatus such as a server can also be connected. A wired network, a wireless network, or a combination of a wired network and a wireless network can be used.

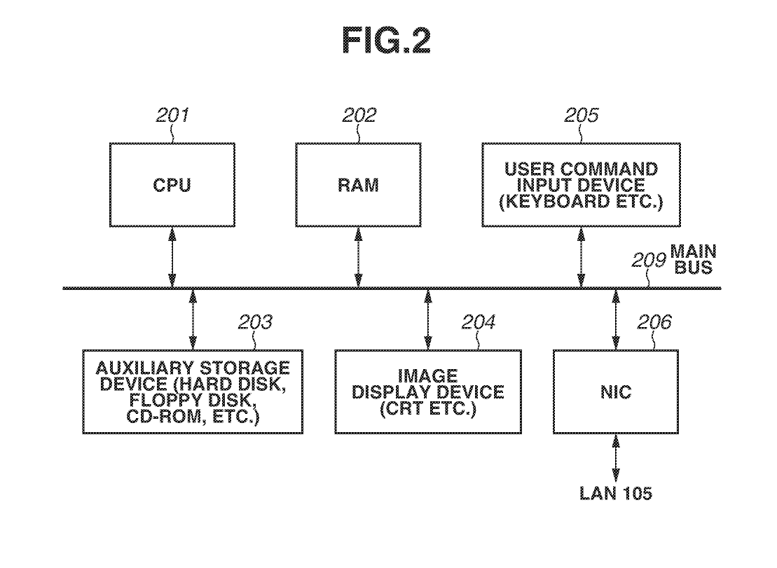

FIG. 2 is a block diagram illustrating an example of an internal configuration of a general information processing terminal and illustrating an internal configuration of the information processing terminal 101 illustrated in FIG. 1. A central processing unit (CPU) 201 performs various kinds of information processing. A random access memory (RAM) 202 provides a work area for the CPU 201. An auxiliary storage device (hard disk, floppy disk, compact disc read only memory (CD-ROM), etc.) 203 provides a control program according to the present exemplary embodiment. An image display device (specifically, cathode ray tube (CRT) display, liquid crystal display, etc.) 204 displays various operation screens and messages for a user. A user command input device (e.g., mouse, keyboard, etc.) 205 inputs a user command. A network interface card (NIC) 206 exchanges data with other network devices via the LAN 105. A main bus 209 is a bus connecting the components described above.

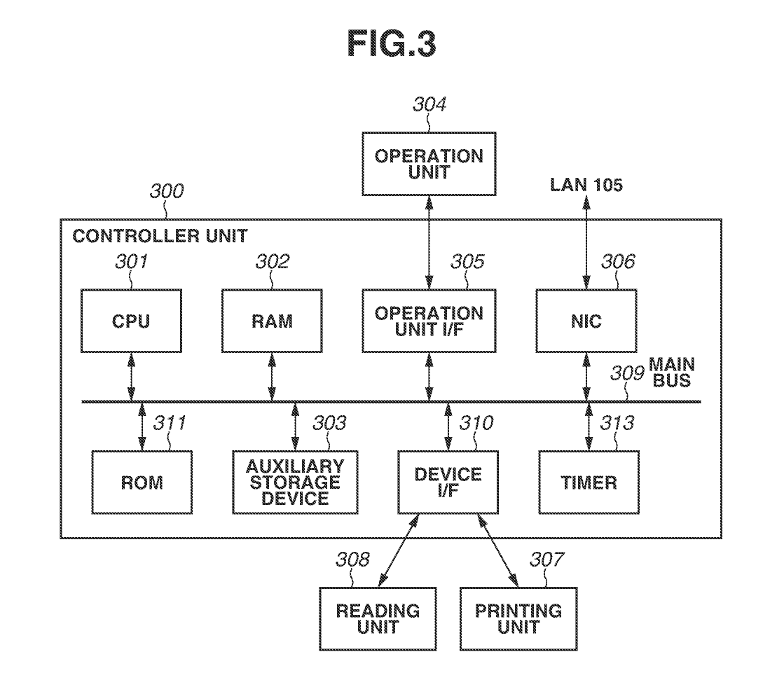

FIG. 3 is a block diagram illustrating an example of an internal configuration of the printing apparatus 111. A controller unit 300 is a device that controls the printing apparatus 111. A CPU 301 performs information processing for controlling the printing apparatus 111. A RAM 302 is a random access memory for storing programs such as an operation system (OS), system software and application software, and various data, provides a work area for the CPU 301, and temporarily stores data. A read only memory (ROM) 311 stores a start-up program for the system. The ROM 311 also stores system programs and application programs. The ROM 311 can also store data necessary for printing, such as fonts. An auxiliary storage device (hard disk, CD-ROM, etc.) 303 temporarily stores data and is used instead of the RAM 302. A timer 313 manages time and is used for, for example, determining whether printing of reserved print data is performed at a reserved time. The CPU 301, the RAM 302, the ROM 311, and the auxiliary storage device 303 are connected to a main bus 309. The CPU 301 executes programs loaded into the RAM 302 via the main bus 309, and processes image data and data other than images stored in the ROM 311 or the auxiliary storage device 303. The CPU 301 controls the timer 313. Various interfaces (I/Fs) such as an operation unit interface (I/F) 305, a device I/F 310, and an. NIC 306 are connected to the main bus 309.

The operation unit I/F 305 is an I/F unit with an operation unit 304 including a touch panel, and is used to display the state of the printing apparatus 111, an error message, and the like. Information input by the user via the operation unit 304 is sent to the CPU 301. The NIC 306 is used to bi-directionally exchange data with other network devices via the LAN 105. The device I/F 310 connects a reading unit (scanner) 308 and a printing unit 307, which are image input/output devices, to the controller unit 300 to input and output image data. The reading unit 308 includes a scanner engine. The reading unit 308 optically reads an image on a document that is set on a platen glass (not illustrated) or fed from an automatic document feeder (ADF), and generates image data. The image data input from the reading unit 308 via the device I/F 310 is stored in the RAM 302 or the auxiliary storage device 303. The stored image data is subjected to various image processing, such as conversion, correction, editing, or compression/decompression using application programs loaded into the RAM 302, as needed. In a case of outputting the image data, the image data is output to the printing unit 307 via the device I/F 310. The printing unit 307 includes a printer engine that can perform any one of various types of recording methods, such as an inkjet recording method or an electrophotographic method, and forms an image on a recording medium

The configuration of the printing apparatus 111 is not limited to the configuration illustrated in FIG. 3, as long as advantageous effects of the present disclosure can be obtained. For example, in a printing apparatus including a facsimile function, the controller unit 300 can include an I/F for a model device, which is not illustrated in FIG. 3, and the controller 300 can be connected to a public line via the model to enable facsimile transmission. The controller unit 300 can include a universal serial bus (USB) I/F (not illustrated) so that the printing apparatus 111 can read image data stored in a flash memory card and perform printing based on the image data.

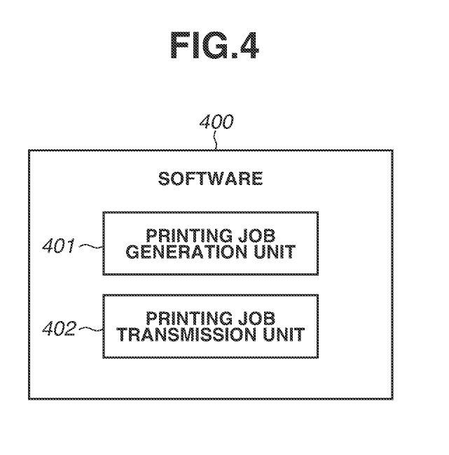

FIG. 4 illustrates an example of a software configuration stored in the auxiliary storage device 203 of the information processing terminal 101. Control modules 401 and 402 (printing job generation unit 401 and printing job transmission unit 402) are read from the auxiliary storage device 203 and loaded into the RAM 202 to be executed by the CPU 201.

The printing job generation unit 401 generates a printing job that is acceptable by the printing apparatus 111 based on an instruction from any rendering software, such as a text editor. The printing job transmission unit 402 transmits the printing job generated by the printing job generation unit 401 to the printing apparatus 111. Control modules 401 and 402 are read from the auxiliary storage device 203 and loaded into the RAM 202 to be executed by the CPU 201.

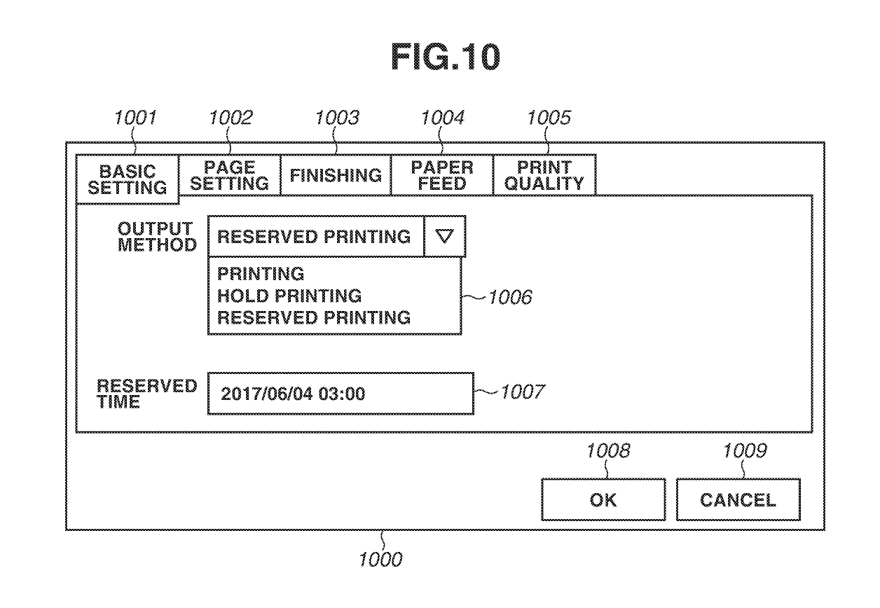

FIG. 10 illustrates an example of a print setting screen that is displayed on the image display device 204 by the printing job generation unit 401 to accept a print setting from the user. The user can make various print settings, such as the number of copies, staple setting, punching setting, paper feed setting, resolution setting, and printing color, by selecting menus 1001 to 1005. For example, a setting for a page layout, such as 2-in-1, can be made by selecting the page setting menu 1002, and a setting for stapling and punching can be made by selecting the finishing menu 1003.

A pull-down menu 1006 is used to designate an output method for a printing job. In the present exemplary embodiment, assume that the user can select “printing”, “hold printing”, and “reserved printing” as the output method 1006. Also, assume that, when the user selects reserved printing as the output method 1006, a reserved time 1007 is also designated. The reserved time can be an absolute time (Greenwich Mean Time (GMT)) or a relative time (e.g., after two hours and 30 minutes) with respect to the current time. In the present exemplary embodiment, assume that the user designates the absolute time. When the user presses an OK button 1008 on a print setting screen 1000, the printing job generation unit 401 generates a printing job 1500 and transmits the printing job 1500 to the printing apparatus 111 via the printing job transmission unit 402.

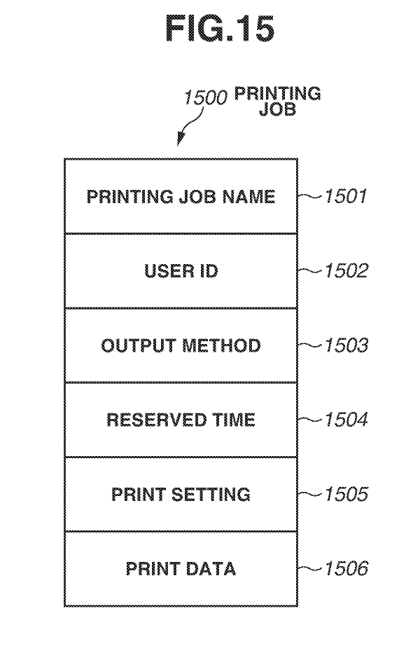

FIG. 15 illustrates an example of the printing job generated by the printing job generation unit 401. The printing job 1500 includes a printing job name 1501 and a user ID 1502 for identifying the user who uses the information processing terminal 101. In the present exemplary embodiment, assume that the user ID that is used to log into the information processing terminal 101 is automatically set in the printing job, but can be set by other methods. For example, the user can explicitly designate the user ID 1502 on the print setting screen 1000. An output method 1503 is the output method 1006 designated by the user on the print setting screen 1000. A reserved time 1504 corresponds to the reserved time 1007 designated by the user on the print setting screen. 1000. A print setting 1505 indicates a print setting, such as a number of copies, staple setting, punching setting, paper feed setting, resolution setting, and printing color. Print data 1506 is print data instructed from any rendering software, such as a text editor.

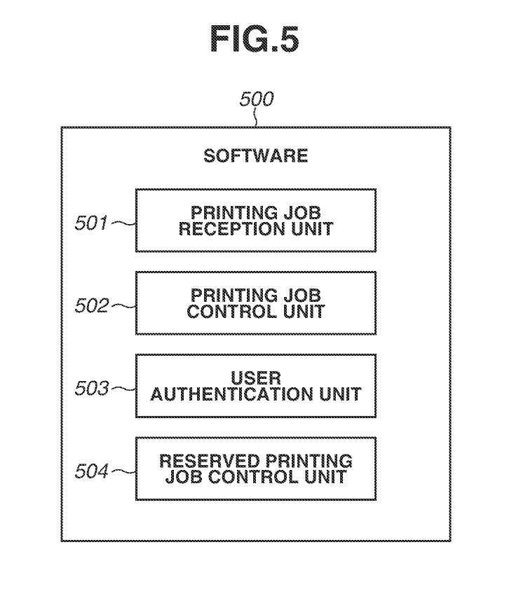

FIG. 5 illustrates an example of a software configuration stored in the auxiliary storage device 303 of the printing apparatus 111. Control modules 501 to 503 (printing job reception unit 501, printing job control unit 502, and user authentication unit 503) are read from the auxiliary storage device 303 and loaded into the RAM 302 to be executed by the CPU 301.

The printing job reception unit 501 receives the printing job 1500 from the information processing terminal 101 via the NIC 306, and delivers the printing job 1500 to the printing job control unit 502. The printing job control unit 502 analyzes the printing job 1500 input from the information processing terminal 101, and is used when the printing unit 307 performs printing based on the printing job 1500 stored in the auxiliary storage device 303. The user authentication unit 503 identifies the user who uses the printing apparatus 111. User authentication information can be input from the operation unit 304. A reserved printing job control unit 504 manages printing jobs in which reserved printing is made as the output method 1503 from among the printing jobs managed by the printing job control unit 502.

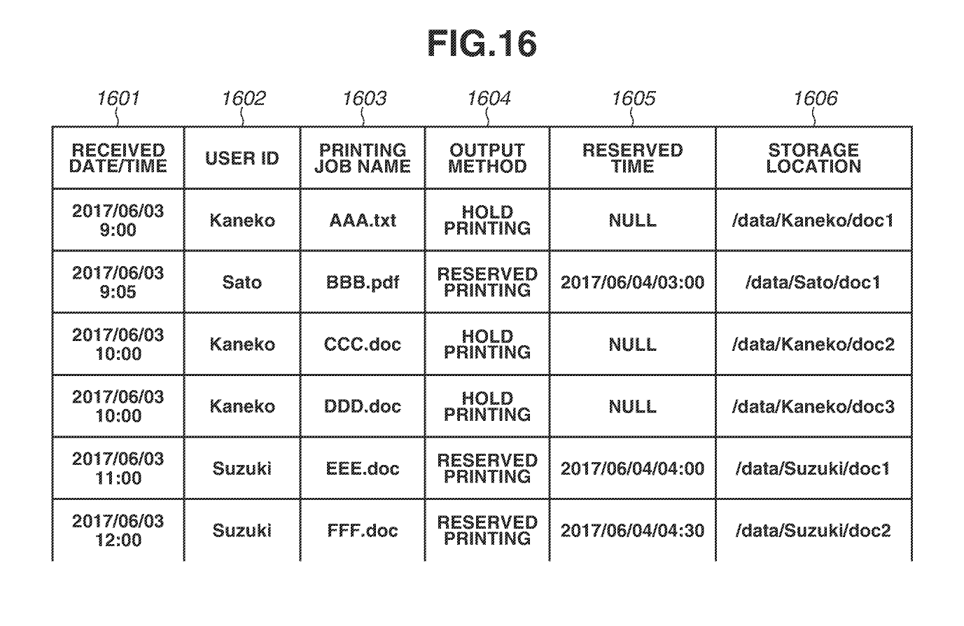

FIG. 16 illustrates a printing job list used for the printing job control unit 502 to manage printing jobs stored in the auxiliary storage device 303. A printing job list 1600 indicates a list of printing jobs for which printing is not completed. The printing job list 1600 includes hold printing jobs in which “hold printing” is designated as the output method, and reserved printing jobs in which “reserved printing” is designated as the output method. Assume that the printing job list 1600 is stored in the auxiliary storage device 303 or the RAM 302 and the printing job control unit 502 can read and write information at any time.

In the printing job list 1600, a reception date/time 1601 indicates a date and time when the printing job acceptance unit 501 receives the printing job 1500. A user ID 1602 corresponds to the user ID 1502 included in the printing job 1500. A printing job name 1603 corresponds to the printing job name 1501 included in the printing job 1500. An output method 1604 is information indicating an output method for a printing job stored in the auxiliary storage device 303. When the printing job control unit 502 stores the printing job 1500 as a reserved printing job through the reserved printing job control unit 504, “reserved printing” is set as the output method 1604. When the printing job control unit 503 stores the printing job 1500 as a hold printing job, “hold printing” is set as the output method 1604. A reserved time 1605 corresponds to the reserved time 1504 included in the printing job 1500. A storage location 1606 is a storage location for the printing job 1500 stored in the auxiliary storage device 303 by the printing job control unit 502. By referring to the storage location 1606, the printing job control unit 502 can uniquely specify the printing job 1500 stored in the auxiliary storage device 303.

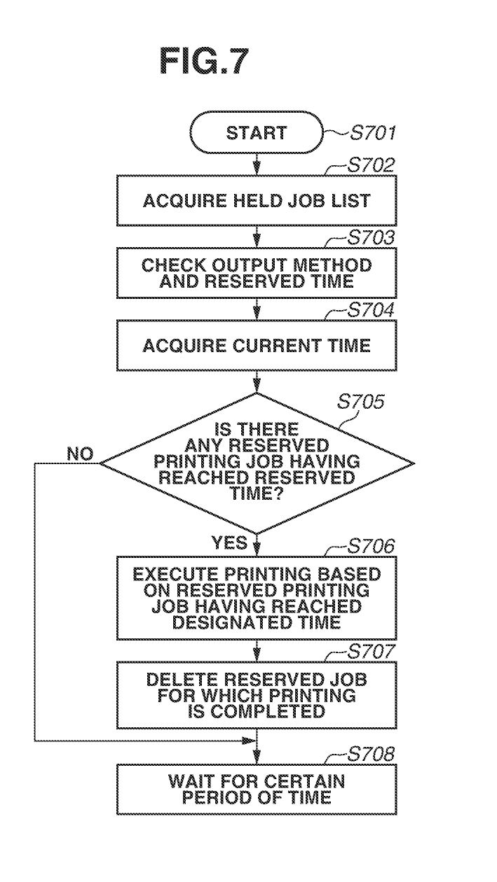

FIG. 7 is a flowchart illustrating details of print processing for the reserved printing job stored in the auxiliary storage device 303. The processing of FIG. 7 is implemented by, for example, the CPU 301 loading a program stored in the ROM 311 into the RAM 302 and executing the program.

In the present exemplary embodiment, assume that the reserved printing job control unit 504 periodically refers to the printing job list 1600 to perform print processing for the reserved printing job that has reached a reserved time.

First, in step S702, the reservation job control unit 504 refers to the printing job list 1600, and then in step S703, the reservation job control unit 504 checks the output method 1604 and the reserved time 1605. Next, in step S704, the reservation job control unit 504 acquires the current time from the timer 313, and in step S705, the reservation job control unit 504 checks whether there is any reserved printing job that has reached the reserved time 1605 checked in step S703.

In step S705, if it is determined that there is a reserved printing job that has reached the reserved time (YES in step S705), the processing proceeds to step S706 and the reservation job control unit 504 executes print processing based on the reserved printing job. Then, in step S707, the reserved printing job control unit 504 deletes, from the auxiliary storage device 303, the reserved printing job for which printing is completed, and also deletes information about the reserved printing job from the printing job list 1600. Next, in step S708, the reserved printing job control unit 504 waits for a certain period of time (e.g., 10 seconds), and performs the processing of S702 again. In step S705, if it is determined that there is no print reservation job that has reached the reserved time (NO in step S705), the processing proceeds to step S708 to wait for a certain period of time, and then the processing of step S702 is performed again.

The processing in the above-described flowchart is implemented by the method of periodically checking the reserved time in the printing job list 1600, but the processing can also be implemented by other methods. For example, an earliest reserved time from among the reserved times for the reserved printing jobs included in the printing job list 1600 can be set to the timer 313. The processing can be started when the current time reaches the set time, and print processing based on the reserved printing job for which the time is designated as the reserved time can be performed.

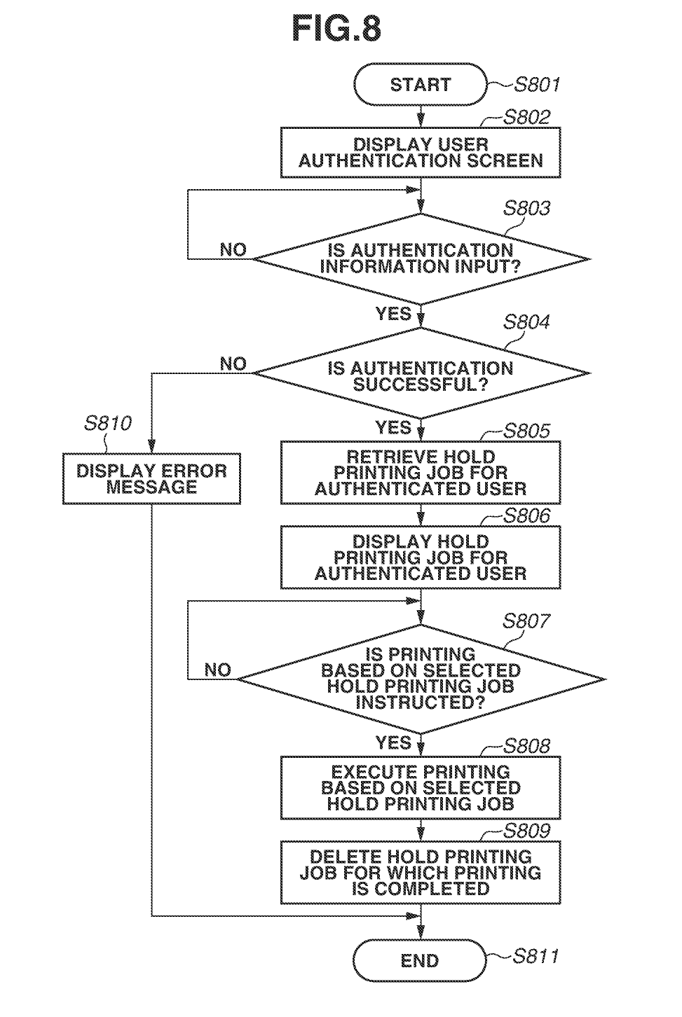

FIG. 8 is a flowchart illustrating an outline of processing of performing print processing based on a hold printing job stored in the auxiliary storage device 313 based on an instruction from the user. The processing of FIG. 8 is implemented by, for example, the CPU 301 loading a program stored in the ROM 311 into the RAM 302 and executing the program.

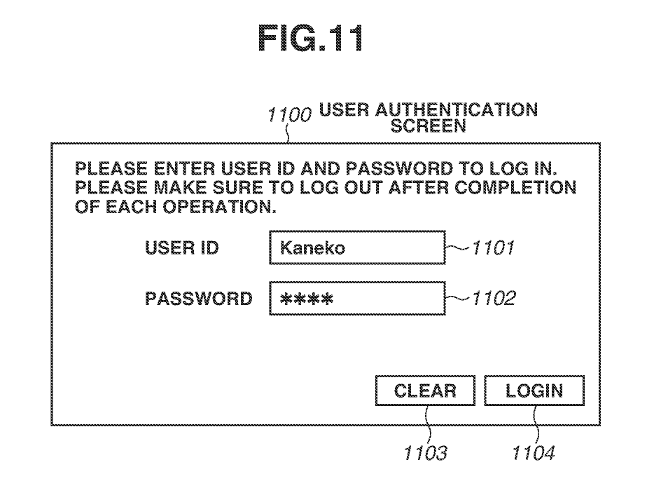

First, in step S802, the user authentication unit 503 displays a user authentication screen 1100 illustrated in FIG. 11 on the operation unit 304. The user authentication screen 1100 includes an area 1101 for inputting a user ID, an area 1102 for inputting a password, a clear button 1103 for initializing a content input in the area 1101 or 1102, and a login button 1104 that is used to execute user authentication processing.

In step S803, if the user inputs a user ID and a password and presses the login button 1104 (YES in step S803), the processing proceeds to step S804. In step S804, the user authentication unit 503 performs user authentication processing. As a method for user authentication processing, a list of user IDs and passwords for users who are authorized to log in the printing apparatus 111 is stored in the auxiliary storage device 303 as a database, and the user ID and password input by the user are compared with the database. The method for user authentication processing is not limited to this method. For example, an authentication server can be externally provided to execute authentication processing based on the input user ID and password, and the printing apparatus 111 can receive the authentication result from the authentication server.

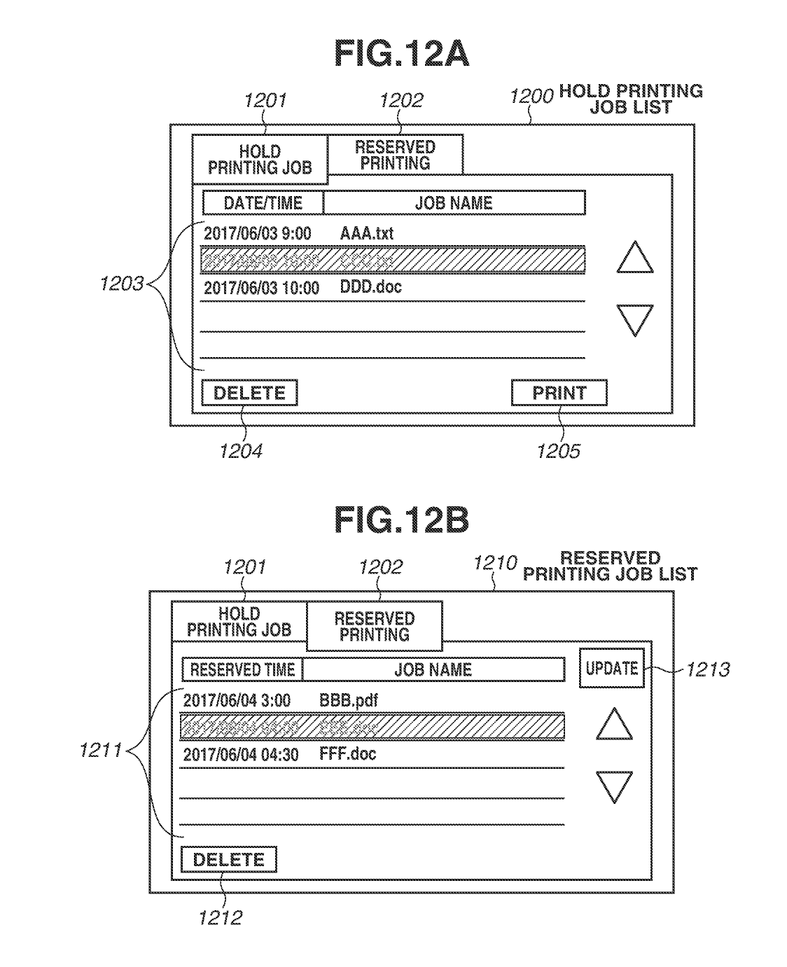

If the user authentication is successful (YES in step S804), the processing proceeds to step S805. In step S805, the printing job control unit 502 retrieves a hold printing job of the authenticated user by referring to the user ID and the output method 1604 in the printing job list 1600. In step S805, the hold printing job of the authenticated user is retrieved, and then in step S806, the printing job control unit 502 displays a hold printing job list 120( )illustrated in FIG. 12A on the operation unit 304.

In the hold printing job list 1200, an area 1203 is used to display contents of hold printing jobs in a list. In this case, a list of hold printing jobs in a case where a user with a user ID: Kaneko has logged in is displayed. A display area for items relating to the printing jobs in the list display area 1203 includes a function of a selection button for selecting a printing job. A button 1204 is used to delete the selected hold printing job. A button 1205 is used to perform printing of the selected hold printing job.

When the user selects a menu of a reserved printing 1202 in the hold printing job list 1200, the reserved printing job control unit 504 displays a reserved printing job list 1210 illustrated in. FIG. 12B on the operation unit 304. The reserved printing job list 1210 includes an area 1211 for displaying contents of reserved printing jobs in a list, a button 1212 for deleting the selected reserved printing job, and a button 1213 for updating information about the reserved printing job displayed in the list display area 1211.

Referring back to FIG. 8, if the user selects any job and presses the printing button 1205 in the printing job list 1200 (YES in step S807), the processing proceeds to step S808. In step S808, the printing job control unit 502 causes the printing unit 307 to perform printing based on the selected hold printing job. In S809, the printing job control unit 502 deletes, from the auxiliary storage device 303, the hold printing job for which printing is completed, and also deletes information about the hold printing job from the printing job list 1600.

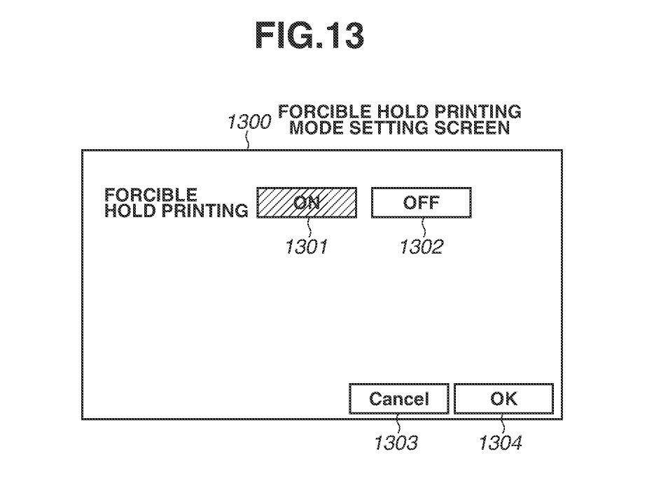

FIG. 13 illustrates a forcible hold printing mode setting screen 1300 for setting whether the forcible hold printing mode is enabled in the printing apparatus 111. The forcible hold printing mode setting screen 1300 is displayed on the operation unit 304 through an operation by an administrator. The term “forcible hold printing mode” used herein refers to a mode in which the received printing job is stored in the auxiliary storage device 303 as a hold printing job, regardless of whether “hold printing” is set in the received printing job. Printing processing based on a held printing job is performed by the above-described method with reference to FIG. 8.

When the user presses an OK button 1303 in a state where an ON button 1301 is selected on the forcible hold printing mode setting screen 1300, the printing apparatus 111 operates in the forcible hold printing mode. When the user presses the OK button 1303 in a state where an OFF button 1302 is selected, the printing apparatus 111 operates in a non-forcible hold printing mode. Information indicating whether the forcible hold printing mode is enabled is stored in the auxiliary storage device 303 by the printing job control unit 502.

In the present exemplary embodiment, assume that in a case where the forcible hold printing mode is ON, the printing job control unit 502 stores the received printing job 1500 in the auxiliary storage device 303 as the hold printing job, regardless of the output method 1503 for the printing job 1500 received by the printing job acceptance unit 501. This processing will be described in detail below.

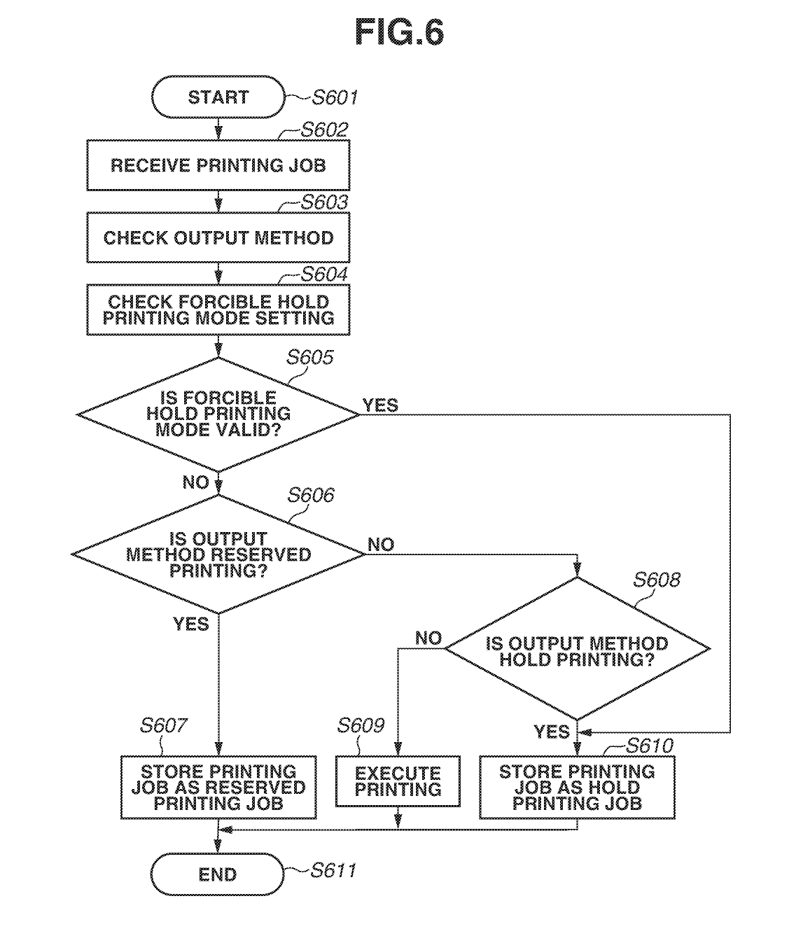

FIG. 6 is a flowchart illustrating details of processing to be performed when the printing job 1500 is received. The processing of FIG. 6 is implemented by, for example, the CPU 301 loading a program stored in the ROM 311 into the RAM 302 and executing the program.

In step S602, the printing job acceptance unit 501 receives the printing job 1500. In step S603, the printing job control unit 502 checks the output method 1503 included in the printing job 1500. Next, in step S604, the printing job control unit 502 checks the information stored in the auxiliary storage device 303 and indicating whether the forcible hold printing mode is enabled.

As a result thereof, if the forcible hold printing mode is not enabled (NO in step S605), the processing proceeds to step S606. In step S606, the printing job control unit 502 determines whether the output method 1503 is “reserved printing” based on the result of the checking in step S603. If the output method is “reserved printing” (YES in step S606), the processing proceeds to step S607. In step S607, the printing job control unit 502 stores the printing job 1500 as the reserved printing job through the reserved printing job control unit 504. More specifically, the reserved printing job control unit 504 stores the printing job 1500 in the auxiliary storage device 303 and adds the output method 1604 into the printing job list 1600 as “reserved printing”.

In step S606, if it is determined that the output method is not “reserved printing” (NO in step S606), the processing proceeds to step S608. In step S608, the printing job control unit 502 determines whether the output method is “hold printing”. If it is determined that the output method is not “hold printing” (NO in step S608), the processing proceeds to step S609. In step S609, the printing job control unit 502 causes the printing unit 307 to execute printing as a normal printing job. If it is determined that the output method is “hold printing” (YES in step S608), the processing proceeds to step S610. In step S610, the printing job control unit 502 stores the printing job 1500 as the hold printing job. More specifically, the printing job control unit 502 stores the printing job 1500 in the auxiliary storage device 303 and adds the output method 1604 into the printing job list 1600 as “hold printing”. The printing job list 1600 illustrated in FIG. 16 described above is used when the forcible hold printing mode is not enabled.

If it is determined that the forcible hold printing mode is enabled (YES in step S605), the processing proceeds to step S610. In step S610, the printing job control unit 502 stores the printing job 1500 as the hold printing job, regardless of the designated output method. For example, even if “reserved printing” is set as the output method 1503 for the printing job 1500, the printing job control unit 502 stores the printing job 1500 as the hold printing job. More specifically, the printing job control unit 502 stores the printing job 1500 in the auxiliary storage device 303 and adds the output method 1604 into the printing job list 1600 as “hold printing”, instead of adding the output method 1604 as “reserved printing” thereto. In this case, the reserved time 1504 set for the printing job 1500 is disabled.

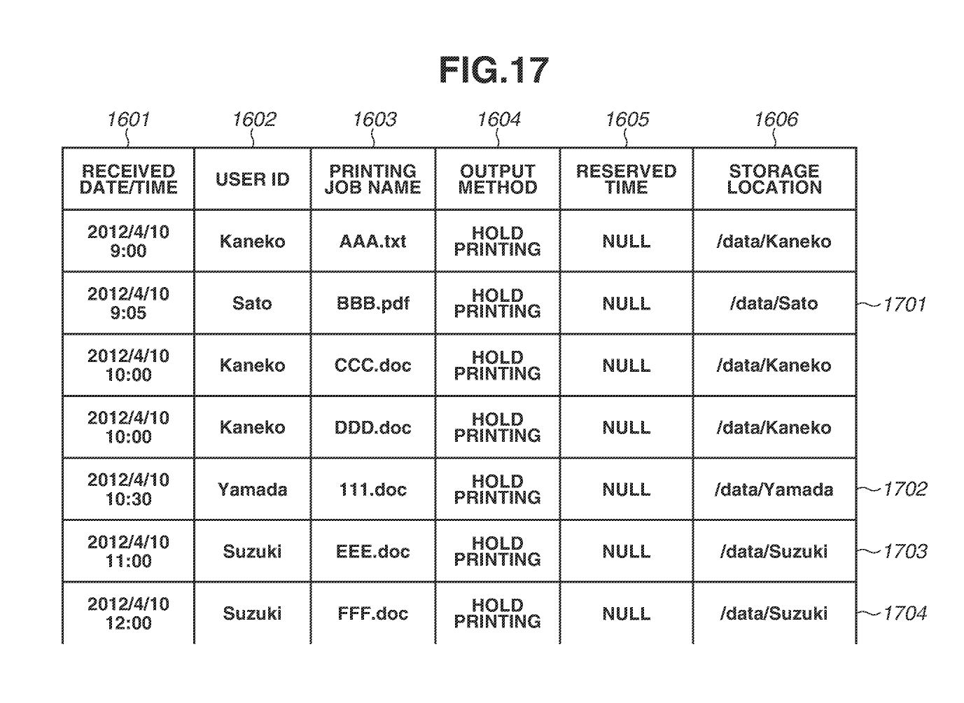

FIG. 17 illustrates the printing job list 1600 used when the forcible hold printing mode is enabled. FIG. 17 differs from FIG. 16 in that “hold printing” is set as the output method 1604 for the printing jobs, such as printing jobs 1701, 1703, and 1704, in which the output method 1604 is set as “reserved printing” when the forcible hold printing mode is disabled. The reserved time 1605 for these printing jobs is disabled. Like printing job 1702, a printing job that is not present in the printing job list when the forcible hold printing mode is disabled is newly added. In this printing job, “printing” is designated as the output method 1503 and thus printing is promptly performed when the forcible hold printing mode is disabled.

As described above, the printing apparatus 111 according to the present exemplary embodiment includes a reserved printing function in which when print data for which a print time is designated is received from an external device, the print data is stored and print processing based on the print data is executed at the designated print time. The printing apparatus 111 includes a hold printing function for storing received print data without promptly performing printing based on the received print data, and performing print processing based on the print data after waiting for a print instruction from the user with respect to the printing apparatus 111. In this way, the printing environment in which “hold printing” is intended to prevent a printed material from being printed without the user being present and “reserved printing” intended to prevent another user's work from being interrupted are selectable can be implemented. When the printing apparatus 111 receives a reserved printing job during the operation in the forcible hold printing mode, the printing apparatus 111 can process the reserved printing job as the hold printing job. Consequently, it is possible to continuously prevent a printed material from being printed without the user being present.

In the present exemplary embodiment, an example is described where a reserved printing job received when the forcible hold printing mode is set is stored as a hold printing job. However, the received printing job can be cancelled instead of storing the received reserved printing job as the hold printing job. When the forcible hold printing mode is set, the reserved printing job is not accepted, thereby preventing disclosure of information caused by printing material without the user being present.

In the first exemplary embodiment, an example is described where when the printing apparatus 111 receives a reserved printing job during the operation in the forcible hold printing mode, the printing job control unit 502 converts the received reserved printing job into a hold printing job or cancels the received reserved printing job. In a second exemplary embodiment, a method will be described in which the printing apparatus 111 preliminary sets whether to convert a reserved printing job received during the operation in the forcible hold printing mode into a hold printing job or cancel the received reserved printing job. A configuration of the printing system, an internal configuration and software of the information processing terminal, an internal configuration and software of the printing apparatus 111, a configuration of the printing job, a configuration of the printing job list, and the like are the same as those of the first exemplary embodiment, and thus descriptions thereof are omitted. In the present exemplary embodiment, differences between the first exemplary embodiment and the second exemplary embodiment are mainly described.

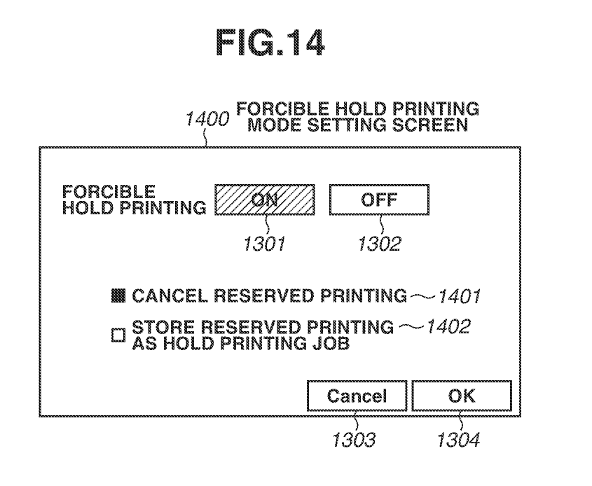

FIG. 14 illustrates a forcible hold printing mode setting screen 1400 according to the second exemplary embodiment. FIG. 14 differs from FIG. 13 in that UI controls 1401 and 1402 are added. The UI controls 1401 and 1402 are enabled when the ON button. 1301 is selected. The UI control 1401 is a UI control for setting a cancel mode for cancelling the reserved printing job received when the forcible hold printing mode is ON. The UI control 1402 is a UI control for setting a hold/storage mode for storing the reserved printing job received when the forcible hold printing mode is ON as a hold printing job. Information about which of the cancel mode and the hold/storage mode is set is stored in the auxiliary storage device 303 by the printing job control unit 502.

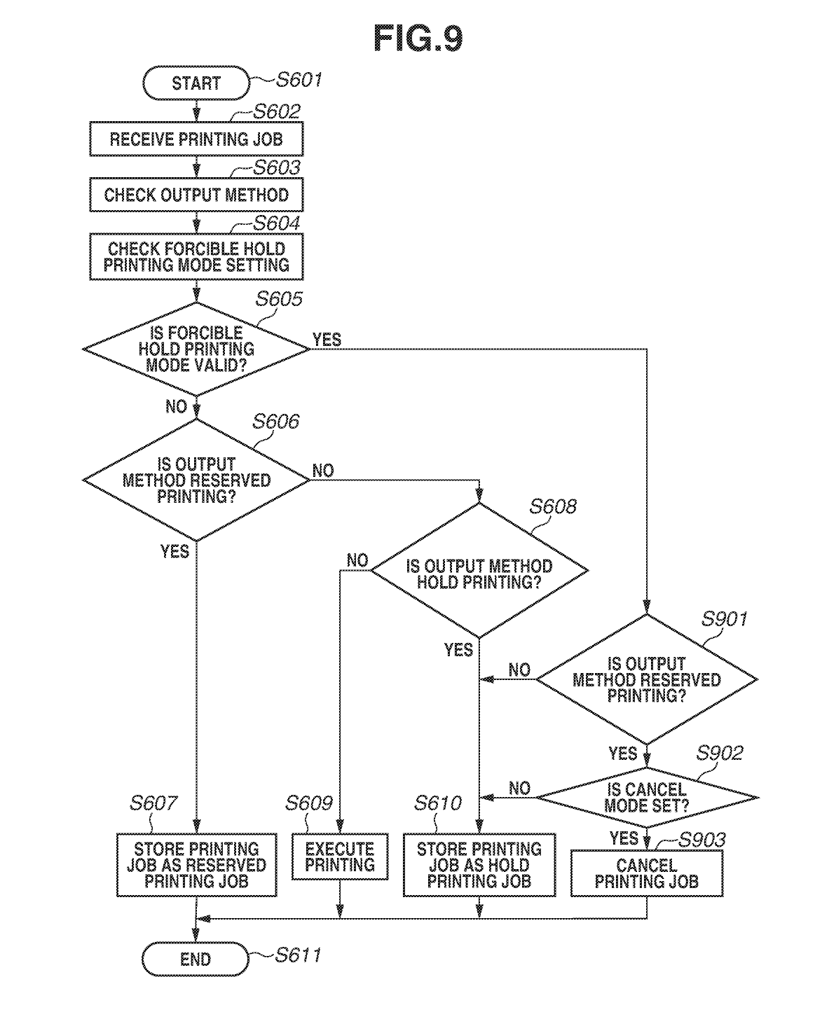

FIG. 9 is a flowchart illustrating details of processing to be performed when the printing job 1500 is received. Processes in FIG. 9 that are the same as the processes in FIG. 6 are denoted by the same reference symbols and detailed descriptions thereof are omitted. The processes in FIG. 9 differ from the processes in FIG. 6 with respect to the processing after step S605 in which it is determined that the forcible hold printing mode is enabled. The processing of FIG. 9 is implemented by, for example, the CPU 301 loading a program stored in the RAM 302 into the RAM 302 and executing e program.

In step S605, if it is determined that the forcible hold printing mode is enabled (YES in step S605), the processing proceeds to step S901. In step S901, the printing job control unit 502 determines whether the output method 1503 is “reserved printing”. If the output method 1503 is not “reserved printing”, i.e., if the output method 1503 is “printing” or “hold printing” (NO in step S901), the processing proceeds to step S610. In step S610, the printing job control unit 502 stores the received printing job 1500 as a hold printing job.

If it is determined that the output method 1503 is “reserved printing” (YES in step S901), the processing proceeds to step S902. In step S902, the printing job control unit 502 determines which of the cancel mode or the hold/storage mode is set. If the cancel mode is set (YES in step S902), the processing proceeds to step S903. In step S903, the printing job control unit 502 cancels the received printing job 1500. If the hold/storage mode is set (NO in step S902), the processing proceeds to step S610. In step S610, the printing job control unit 502 stores the printing job 1500 as the hold printing job. More specifically, the printing job control unit 502 stores the printing job 1500 in the auxiliary storage device 303 and adds the output method 1604 as “hold printing” into the printing job list 1600, instead of adding the output method 1604 as “reserved printing”. In this case, the reserved time 1504 set for the printing job 1500 is disabled.

As described above, according to the present exemplary embodiment, in a case where a reserved printing job is received during the operation in the forcible hold printing mode, it is possible to preliminary select whether to process the reserved printing job as a hold printing job or cancel the reserved printing job. In this way, it is possible to select processing according to a security policy while continuously preventing material from being printed without the user being present.

In the exemplary embodiments described above, an example managing hold printing jobs and reserved printing jobs in an integrated manner as illustrated in FIG. 16, the hold printing jobs and the reserved printing jobs can be individually managed.

According to the above-described exemplary embodiments, it is possible to perform control so as not to perform printing at a designated time in a case where the printing apparatus 111 set in the forcible hold printing mode receives a reserved printing job.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s)and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-191744, filed Sep. 29, 2017, which is hereby incorporated by reference herein in its entirety.

What is claimed is:

1. A printing apparatus that receives a reserved printing job for which a print time is designated and executes printing based on the reserved printing job, the printing apparatus comprising:
a first setting unit configured to set whether to operate in a hold printing mode in which a received printing job is held and printing is executed based on the held printing job based on a print instruction; and
a control unit configured to perform control not to execute print processing of a reserved printing job received during operation in the hold printing mode.

2. The printing apparatus according to claim 1, wherein the control unit stores, in a storage unit, the reserved printing job received during the operation in the hold printing mode as a hold printing job for performing printing based on the print instruction.

3. The printing apparatus according to claim 1, wherein the control unit cancels the reserved printing job received during the operation in the hold printing mode.

4. The printing apparatus according to claim 1, further comprising a second setting unit configured to set whether to store the reserved printing job received during the operation in the hold printing mode as a hold printing job for performing printing based on the print instruction or cancel the reserved printing job,
wherein the control unit performs processing on the reserved printing job received during the operation in the hold printing mode according to the setting by the second setting unit

5. The printing apparatus according to claim 1, wherein, in a case where the printing apparatus is not operating in the hold printing mode based on the setting by the first setting unit, the control unit performs processing on the received printing job based on an output method included in the received printing job.

6. The printing apparatus according to claim 5, wherein the output method included in the printing job is a reserved printing for performing printing based on a designated time, a hold printing for performing printing based on the print instruction from the user, or a normal printing for performing printing upon receipt of a printing job.

7. A control method for a printing apparatus that receives a reserved printing job for which a print time is designated and executes printing based on the reserved printing job, the control method comprising:
setting whether to operate in a hold printing mode in which a received printing job is held and printing is executed based on the held printing job based on a print instruction,
performing control not to execute print processing of a reserved printing job received during operation in the hold printing mode.

8. The control method according to claim 7, wherein, in a case where the reserved printing job is received during the operation in the hold printing mode, the reserved printing job is stored in a storage unit as a hold printing job for performing printing based on the print instruction.

9. The control method according to claim 7, wherein, in a case where the reserved printing job is received during the operation in the hold printing mode, the reserved printing job is canceled.

10. A computer-readable storage medium storing a program for causing a computer to execute a control method for a printing apparatus that receives a reserved printing job for which a print time is designated and executes printing based on the reserved printing job, the control method comprising:
setting whether to operate in a hold printing mode in which a received printing job is held and printing is executed based on the held printing job based on a print instruction; and
performing control not to execute print processing of a reserved printing job received during operation in the hold printing mode.
